(19) United States
(12) Patent Application Publication
(10) Pub. No.: US 2009/0085422 A1
(43) Pub. Date: Apr. 2, 2009

(54) Motor Core Component and Motor Component

(75) Inventors: Kazushi Kusawake, Osaka (JP); Hitoshi Oyama, Osaka (JP); Shinichi Iizuka, Osaka (JP)

Correspondence Address: MCDERMOTT WILL & EMERY LLP, 600 13TH STREET, N.W., WASHINGTON, DC, 20005-3096, US

(73) Assignee: SUMITOMO ELECTRIC INDUSTRIES, LTD., Osaka (JP)

(21) Appl. No.: 11/920,503

(22) PCT Filed: Nov. 7, 2006
(86) PCT No.: PCT/JP2006/322197

§ 371 Date: Nov. 16, 2007

(30) Foreign Application Priority Data
Nov. 11, 2005 (JP) 2005-328125

(51) Int. Cl. H02K 1/14; H02K 3/34; H02K 1/02; H02K 15/095

(52) U.S. Cl. 310/216; 310/215; 310/44; 29/596

(57) ABSTRACT

To provide a core component for making it possible to enhance the space factor of a conductor wire in a storage section, a motor component including the core component, and a forming method of the motor component, the motor component includes a core component 10 shaped like a letter T in transverse cross section and a coil made of a conductor wire 200 wound on a tooth 11 of the core component 10. The core component 10 includes the tooth 11, an outer peripheral piece 12 placed on one end side of the tooth 11, and an inner peripheral piece 13 placed on an opposite end side of the tooth, and a space surrounded by the outer peripheral surface of the tooth 11, an opposed face 12a of the outer peripheral piece 12 to the inner peripheral piece, and an opposed face 13a of the inner peripheral piece 13 to the outer peripheral piece is a coil storage section 14. A step having a height satisfying {D×(√3/2)}×n (D: Diameter of conductor wire and n: Natural number) is provided on the outer peripheral surface of the tooth 11, and step faces 11a and 11b forming the step are made parallel to a virtual face 14a producing the outer shape of the storage section 14.

### TECHNICAL FIELD

This invention relates to a motor core component with an outer periphery on which a conductor wire is wound, a motor component including a coil made of the wound conductor wire wound on the core component, and a forming method of the motor component. It relates in particular to a motor core component for making it possible to enhance the space factor of a conductor wire in a slot for storing a coil (storage section) than was previously possible and a motor component having a higher space factor than ever.

### BACKGROUND ART

Hitherto, a rotor and a stator each having a coil on the outer periphery of a core made of a magnetic material have been widely known as components of a motor.

Annular rotors and stators are generally used; for example, a configuration having a ring-like part, a plurality of cores placed so as to extend radially in the diametric direction of the ring-like part, and a coil provided by winding a conductor wire on the outer periphery of each core can be named (refer to FIG. 8 in patent document 1).

As the cores, there are the integral type wherein the cores are formed integrally with the ring-like part and the separation type wherein the cores can be separated from the ring-like part and a conductor wire can be wound on each of the cores as described in patent document 1.

In the latter separation type cores, each one piece of a core and a coil provided by winding a conductor wire on each core (hereinafter, called motor component) is set on the ring-like part to form a stator.

FIG. 7 (A) is a perspective view of a separation type core in a related art and (B) is a transverse sectional view of a motor component in the related art including the separation type core. The transverse cross section corresponds to the cross section taken on line B-B in FIG. 7 (A).

Known as the separation type core is a core 100 shaped like a letter T in transverse cross section including a tooth 101 with an outer periphery on which a conductor wire 200 is wound, an outer peripheral piece 102 provided on one end side of the tooth 101 and placed on the outer periphery side when the core is placed on a ring-like part 300 and is assembled as a part of a motor, and an inner peripheral piece 103 provided on an opposite end side of the tooth 101 so as to be opposed to the outer peripheral piece 102 and placed on the inner periphery side when the core is assembled as a part of a motor.

In the core 100 shaped like a letter T in transverse cross section, the outer peripheral piece 102 and the inner peripheral piece 103 are provided with parts projected to the outside of the tooth 101 and the space surrounded by the outer peripheral surface of the tooth 101, an opposed face 102a of the outer peripheral piece 102 to the inner peripheral piece 103, and an opposed face 103a of the inner peripheral piece 103 to the outer peripheral piece 102 forms a coil slot (storage section) 104.

The coil is formed by winding the conductor wire 200 along the outer periphery of the tooth 101 between the outer peripheral piece 102 and the inner peripheral piece 103.

As the core 100, a core made up of a core part 100c made of a magnetic material and an insulator 100i made of an insulating material placed on the outer periphery of the core part 100c is also available.

In the example shown in FIG. 7, the insulator 100i is placed in the part corresponding to the slot of the core part 100c and the actual slot 104 is formed by the insulator 100i.

Hitherto, enhancing the space factor of a conductor wire in a slot has been demanded for the motor component. Then, to decrease dead space in the slot (space where a conductor wire cannot be wound) and enhance the space factor of a conductor wire, it is considered that a tooth is formed as a square pyramid frustum rather than as a square pole shape as shown in patent document 1 (refer to patent document 2).

Specifically, the tooth 101 is made up of a pair of first trapezoidal faces 101a each with the width narrowing from the outer peripheral piece side to the inner peripheral piece side and a pair of second trapezoidal faces 101b each with the width widening from the outer peripheral piece side to the inner peripheral piece side.

To enhance the space factor, it is also considered that a flat wire rectangular in transverse cross section rather than a round wire circular in transverse cross section shown in FIG. 7 is used as the conductor wire 200 (refer to patent document 2).

When the motor components are assembled into a motor, the side of one motor component opposed to an adjacent motor component is called coil side and the side not opposed to an adjacent motor component is called coil end side.

Here, the side where the first trapezoidal face 101a is placed becomes the coil end side and the side where the second trapezoidal face 101b is placed becomes the coil side.

The motor component is obtained by setting a core on a rotatable coil winder and winding a conductor wire on the rotating core to form a coil while supplying the conductor wire continuously from a winding nozzle.

The coil made of the wound conductor wire is formed by winding the conductor wire 200 side by side so as to be parallel with the outer peripheral surface of the tooth 101 between the outer peripheral piece 102 and the inner peripheral piece 103 to form one layer in the transverse cross section shown in FIG. 7 (B) and a plurality of such layers are stacked from the outer peripheral surface of the tooth 101 to a virtual face (indicated by the thin alternate long and two short dashes line in FIG. 7 (B)) to form the outer shape of the slot 104.

For example, a first layer in contact with the outer peripheral surface of the tooth 101 is formed by starting to wind the conductor wire 200 from an end part of the outer peripheral piece 102 or an end part of the inner peripheral piece 103 on the outer peripheral surface of the tooth 101 and winding the conductor wire 200 along the outer peripheral surface of the tooth 101 between the outer peripheral piece 102 and the inner peripheral piece 103 and winding the conductor wire until it reaches the end part of one piece (the inner peripheral piece 103 if the winding start is the end part of the outer peripheral piece or the outer peripheral piece 102 if the winding start is the end part of the inner peripheral piece).

When the conductor wire 200 reaches the end part, the conductor wire 200 is folded back and is wound on the first layer in a stack manner to form a second layer. Thus, when the conductor wire reaches the end part of the outer peripheral piece 102 or the inner peripheral piece 103, the conductor wire is folded back to change the layer in such a manner that one conductor layer is stacked on another to form a coil.

Patent document 1: JP-A-2001-25198

Patent document 2: JP-A-2002-369418

### DISCLOSURE OF THE INVENTION

### Problems to be Solved by the Invention

However, with the core in the related art, improvement of the space factor of the conductor wire is limited.

As described above, hitherto, the tooth has been shaped like a square pyramid frustum and further a flat wire has been used as the conductor wire for decreasing the dead space occurring in the slot and improving the space factor of the conductor wire.

However, if such a technique is used, a comparatively large dead space may occur in the slot.

If the surface of the tooth shaped like a square pyramid frustum in the related art is formed of a smooth plane with no step, the number of conductor wire turns wound on the tooth may decrease as the conductor wire goes from the outer peripheral piece side to the inner peripheral piece side and the outer shape of the coil stored in the slot may become like a staircase as shown in FIG. 7 (B) (refer to FIG. 10 in patent document 2).

That is, the conductor wire part placed on the outermost side of the conductor wire forming the coil (the conductor wire forming the outer shape of the coil) becomes a state in which it is placed on different parallel lines in the transverse cross section of the motor component.

The outer shape of the coil becomes shaped like such a staircase, so that a stepped dead space 105 corresponding to the outer shape of the coil is formed.

Thus, in the technique in the related art, if a flat wire is used, further improvement of the space factor is limited. When the motor component with the outer shape of the coil shaped like a staircase is assembled as a part of amotor, it is difficult to enhance the gap accuracy between the adjacent motor components.

Further, since air having insulation effectiveness exists in the dead space, it is hard to release heat of the coil heated by energization with the motor component in the related art having a large dead space.

It is a principal object of the invention to provide a motor core component for making it possible to decrease dead space in a slot and more enhance the space factor of a conductor wire.

It is another object of the invention to provide a motor component having a higher space factor of the conductor wire in the slot using the core component.

It is still another object of the invention to provide a forming method of the motor component.

### Means for Solving the Problems

A motor core component of the invention accomplishes the object particularly by forming a tooth with a step having a specific height. The specific configuration is as follows:

The motor core component of the invention includes a tooth with an outer periphery on which a conductor wire is wound, an outer peripheral piece provided on one end side of the tooth and placed on the outer periphery side when the core component is assembled as a part of a motor, and an inner peripheral piece provided on an opposite end side of the tooth so as to be opposed to the outer peripheral piece and placed on the inner periphery side when the core component is assembled as a part of a motor. In the motor core component of the invention, the space surrounded by the outer peripheral surface of the tooth, an opposed face of the outer peripheral piece to the inner peripheral piece, and an opposed face of the inner peripheral piece to the outer peripheral piece is used as a conductor wire storage section.

The motor core component of the invention is characterized in that the tooth is formed with a step at least in a part of the outer peripheral surface, that the height between the two step faces producing the step satisfies either of the following (1) and (2) (where n is a natural number), and that the step faces and a virtual face forming the outer shape of the storage section are parallel:

(1) {D×(√3/2)}×n when the diameter of the conductor wire is D

(2) t×n when the conductor wire is a square wire and the thickness thereof is t.

A motor component of the invention includes the above-described motor core component and a coil made of a wound conductor wire stored in a storage section of the core component, characterized in that the conductor wire forming the outer shape of the coil is placed on the same line.

In the motor core component of the invention, the tooth is formed with a step having a specific height and the step faces producing the step are made parallel to the virtual face forming the outer shape of the storage section.

If the conductor wire is wound so as to align side by side along the step faces, namely, so as to be aligned on one line, the layer made of the conductor wire is placed so as to be parallel to the virtual face.

If the conductor wire is wound as multiple layers on the layer placed on the tooth along the layer to form a coil, the conductor wire forming each layer is aligned on one line like the conductor wire of the lower layer placed on the tooth (on the step faces) and is placed so as to be parallel to the virtual face.

Thus, if the conductor wire of one continuous length is wound on the tooth having the step faces to form a coil and this coil is stored in the storage section, the conductor wire placed on the outermost side, of the conductor wire producing the coil, namely, the conductor wire forming the outer shape of the coil is placed on the same line and this line becomes parallel to the virtual face.

In the motor component including the tooth shaped like a square pyramid frustum in the related art as shown in FIG. 7, the tooth does not have a step of a specific height and thus the outer shape of the coil becomes step-wise, namely, a step is included.

In contrast, in the motor component using the core component of the invention, the tooth has the step of the specific height and thus the outer shape of the coil can be made smooth with no step.

In the motor component, the conductor wire forming the outer shape of the coil is parallel with the virtual face of the storage section, so that a stepped dead space does not occur in the storage section.

Thus, in the motor component using the core component of the invention, the dead space in the storage section can be made smaller than that of the motor component in the related art and the space factor of the conductor wire can be more enhanced.

Since the dead space is small, an air layer having insulation effectiveness can be decreased, so that heat dissipation can be enhanced with the motor component including the core component of the invention.

The invention will be discussed below in more detail:

The core component of the invention includes the tooth with the outer periphery on which a conductor wire is wound, the outer peripheral piece provided on one end side of the tooth, and the inner peripheral piece provided on the opposite end side of the tooth so as to be opposed to the outer peripheral piece.

The outer peripheral piece and the inner peripheral piece include parts projected to the outside of the tooth so as to provide a space surrounded by the outer peripheral surface of the tooth, the opposed face of the outer peripheral piece to the inner peripheral piece, and the opposed face of the inner peripheral piece to the outer peripheral piece.

This means that the core component of the invention is formed so that the transverse cross section and the longitudinal cross section are shaped each like a letter T.

The transverse cross section of the core component (motor component) is a face (which will be hereinafter called axial surface) containing the center axis of the coil made of a wound wire on the tooth (which will be hereinafter called coil center axis) and is a cross section when the core component is cut on the face orthogonal to the rotation shaft of a motor when the core component is assembled as a part of the motor, and the longitudinal cross section is a cross section when the core component is cut on the face orthogonal to the transverse cross section, of the axial surface.

The transverse cross section of the conductor wire is a cross section when the conductor wire is cut so as to be orthogonal to the axial direction of the conductor wire.

When the core component is used for a motor component, the space surrounded by the outer peripheral surface of the tooth and the two opposed faces is used as the storage section of the coil provided by winding a conductor wire.

The plane produced by virtual lines connecting the end part of the outer peripheral piece and the end part of the inner peripheral piece becomes the virtual face forming the outer shape of the storage section.

In the motor component, usually the coil is stored in the storage section so as not to project from the virtual face.

Preferably, the opposed face of the outer peripheral piece to the inner peripheral piece and the opposed face of the inner peripheral piece to the outer peripheral piece are provided so as to be parallel with each other.

Particularly, preferably the opposed faces are provided so as to be orthogonal to the outer peripheral surface of the tooth.

When a conductor wire is wound on the tooth as multiple layer, usually the conductor wire is folded back in the end parts of the outer peripheral piece and the inner peripheral piece, namely, on the opposed faces, and the conductor wire is wound as the next layer.

When the conductor wire is folded back, the winding direction is changed from S twist to Z twist or from Z twist to S twist. To thus wind the conductor wire, if the opposed faces and the outer peripheral surface of the tooth are orthogonal to each other, the opposed face becomes abutment stop when the conductor wire is folded back, so that when the conductor wire is advanced to the next layer, occurrence of winding shift following the winding direction (twist) of the preceding layer can be prevented.

The sizes of such an outer peripheral piece and an inner peripheral piece may be selected appropriately in response to the size of the tooth, the size of the ring-like section for supporting the core components.

Typically, a square pole shape can be named as the shapes of the outer peripheral piece and the inner peripheral piece.

To shape the outer peripheral piece and the inner peripheral piece each like a square pole, the face of the outer peripheral piece opposed to the face of the side coming in contact with the tooth (face placed on the outermost side when the core component is assembled as a part of a motor) and the face of the inner peripheral piece opposed to the face of the side coming in contact with the tooth (face placed on the innermost side) may be flat faces or may be curved faces; they may be selected appropriately conforming to the shape of the ring-like section for supporting the core components.

As the shape of the tooth, a square pole shape as described in patent document 1 (shape wherein the face forming the outer shape are made up of faces parallel to the coil center axis) is well known; however, if a square pole shape is adopted, the dead space in the slot increases and therefore it is difficult to enhance the space factor of the conductor wire in the slot and enhance heat dissipation.

Then, preferably the shape of the tooth is a shape for making it possible to more decrease the dead space in the slot; specifically a shape having a slope can be named.

The slope refers to a face with an extension face crossing the coil center axis. As the shape of the tooth having such a slope, for example, in addition to n angular pyramid shape (n is a natural number of three or more) with a flat face as a slope, non-angular pyramid shapes such as a truncated cone shape and a trapezoidal cone shape with a curved face as a slope can be named.

To shape the tooth like an n angular pyramid, at least one face of n faces on which a conductor wire is wound is made a slope; preferably, two opposed faces are made slopes; more preferably, all faces are made slopes like the non-angular pyramid shape. The inclination angle of the slope (angle relative to the coil center axis) may be selected appropriately in response to the number of the storage sections (slots) provided in motor component, the size of the motor component, any desired motor characteristic, etc., so as not to decrease the capacity of the storage section as much as possible; for example, it can be about 5 to 15°.

In the core component of the invention, the outer peripheral surface of the tooth is made parallel with the virtual face forming the outer shape of the storage section regardless of the tooth of the shape having a slope or the tooth having a face parallel to the coil center axis.

The space factor (%) refers to (conductor cross-sectional area)/(cross-sectional area of storage section)×100. The conductor cross-sectional area refers to the sum total of the cross-sectional areas of the conductor wire forming a coil.

If the conductor wire includes an insulating coating, the cross-sectional area except for the insulating coating is adopted as the conductor cross-sectional area. The cross sections of the conductor wire and the storage section are cross sections in the same direction (transverse or longitudinal cross section).

Typically, a square pyramid frustum can be named as the n angular pyramid shape.

To shape the tooth like a square pyramid frustum, I. configuration wherein one of four faces on which a conductor wire is wound is made a slope and the remaining three are made faces parallel with the coil center axis; II. configuration wherein two faces are made slopes and the remaining two are made faces parallel with the coil center axis; and III. configuration wherein four faces are all made slopes are possible.

In the I or II configuration, the two opposed faces can be shaped each like a trapezoid with the width narrowing (or widening) from the outer peripheral piece side to the inner peripheral piece side and the remaining two can be shaped each like a rectangle.

In the III configuration, the two opposed faces can be made first trapezoidal faces each with the width narrowing from the outer peripheral piece side to the inner peripheral piece side and the remaining two opposed faces can be made second trapezoidal faces each with the width widening from the outer peripheral piece side to the inner peripheral piece side.

The widths of the adjacent faces are changed alternately as in the III configuration, whereby when the tooth is cut so as to be orthogonal to the coil center axis, the cross-sectional area (magnetic path area) can be made substantially equal. Although a magnetic flux passes through the tooth of the core component at the motor using time, if the tooth has such a shape with the magnetic path area lessening from the outer peripheral piece side to the inner peripheral piece side (one type of the II configuration), there is a possibility that the magnetic flux density may increase and the magnetic flux may be saturated on the inner peripheral piece side.

Therefore, the tooth is configured so that the magnetic path area becomes equal from the outer peripheral piece side to the inner peripheral piece side, so that the magnetic characteristic of the tooth can be made uniform from the outer peripheral piece side to the inner peripheral piece side.

In the invention, the tooth as described above is formed with a step at least in a part of the outer peripheral surface. For example, to shape the tooth like an n angular pyramid, the tooth is formed with a step on at least one face of n faces on which a conductor wire is wound; preferably, on the two opposed faces; more preferably, over all faces of the outer peripheral surface.

To shape the tooth like a non-angular pyramid, preferably the tooth is also formed with a step over all faces of the outer peripheral surface.

The tooth shaped like an n angular pyramid or the tooth shaped like a non-angular pyramid is formed with a step over all faces of the tooth, whereby when the cross section of the tooth is taken so as to be orthogonal to the coil center axis, the cross-sectional area (magnetic path area) can be made substantially equal and the magnetic characteristic of the tooth can be made uniform from the outer peripheral piece side to the inner peripheral piece side.

In the invention, the step height (height between the two step faces producing the step) is defined.

Specifically, the step height is defined in response to the shape of the conductor wire wound on the tooth.

A round wire circular in transverse cross section or a flat wire rectangular in transverse cross section is often used as the conductor wire forming a coil included in a motor component. To use a round wire as a conductor wire and normally wind the conductor wire over multiple layers, the conductor wire is stacked so that the conductor wire of the next layer is fitted into the gap produced between the adjacent lines of the conductor wire as shown in FIG. 8.

Thus, each layer of the stacked conductor wire rises by A={D×(√3/2)} where D is the diameter of the round wire.

Therefore, if a step having a height satisfying expression 1: {D×(√3/2)}×n (where n is a natural number) is appropriately provided on the outer peripheral surface of the tooth, the outer shape of a coil formed by winding the conductor wire along the outer peripheral surface of the tooth having the step can be made smooth with no step.

Then, in the core component of the invention, forming a step satisfying {D×(√3/2)}×n where D is the diameter of the conductor wire and n is a natural number on the outer peripheral surface of the tooth is proposed. Any other conductor wire than the round wire circular in transverse cross section may be used if it is a conductor wire stacked as it rises by {D×(√3/2)}.

On the other hand, to use a square wire such as a flat wire as a conductor wire and normally wind the conductor wire over multiple layers, each layer of the stacked conductor wire rises by t where t is the thickness of the square wire.

Therefore, if a step having a height satisfying expression 2: t×n (where n is a natural number) is appropriately provided on the outer peripheral surface of the tooth, the outer shape of a coil formed by winding the conductor wire along the outer peripheral surface of the tooth having the step can be made smooth with no step.

Then, in the core component of the invention, to use a square wire as a conductor wire, forming a step satisfying t×n where the thickness of the conductor wire is t and n is a natural number on the outer peripheral surface of the tooth is proposed.

Any other conductor wire than the flat wire rectangular in transverse cross section may be used if it is a conductor wire stacked as it rises by t.

For example, a polygonal wire polygonal in transverse cross section such as a conductor wire hexagonal in transverse cross section can be named.

The step height may be provided so as to satisfy expression 1: {D×(√3/2)}>X n or expression 2: t X n as described above, and n (natural number) may be an odd number or may be an even number. If n is set to an odd number, as many conductor wire lines as the odd number are stacked at each step; if n is set to an even number, as many conductor wire lines as the even number are stacked at each step.

To form a coil on the tooth including a step having a height satisfying expression 1 or expression 2 where n is an odd number, for example, the following procedure is executed. A conductor wire is wound along the outer peripheral surface of the tooth as it starts at an end part of the outer peripheral piece or an end part of the inner peripheral piece and when the conductor wire reaches the end part of the outer peripheral piece or the end part of the inner peripheral piece, the conductor wire is folded back and is wound so that it is stacked on the layer made of the already wound conductor wire.

When the conductor wire reaches a step, it is folded back in a similar manner to the folding back at the end part of the outer peripheral piece, etc., described above or is ascended along the step. To wind the conductor wire as multiple layers to form a coil, most layers are formed so as to ascend a staircase along the step.

That is, during the winding, the outer shape of the layers formed by the conductor wire wound between the outer peripheral piece and the inner peripheral piece becomes step-wise along the step of the tooth.

Thus, to ascend the step, ascending treatment is performed and to descend the step, descending treatment is performed. The ascending (descending) treatment refers to treatment of adjusting the feeder pitch of a winding nozzle when the conductor wire forming one layer (m) ascends (descends) a step.

To form the last layer forming the outer shape of a coil, wire jump treatment is performed as required.

When a transition is made from one layer (m) to the next layer (m+1), if the termination of the mth layer and the beginning end of the m+1st layer are apart from each other, the wire jump treatment refers to treatment of simply passing the conductor wire to make connection from the termination to the beginning end.

Therefore, the conductor wire passed by the wire jump treatment exists partially in the circumferential direction of the tooth and is not completely wound on the outer peripheral surface of the tooth.

Particularly, to form the outermost layer, if wire jump treatment is performed, the beginning of the conductor wire to be jumped, namely, the termination of the layer m is positioned at the end part of the outer peripheral piece or the end part of the inner peripheral piece.

Therefore, the end parts can be used as abutment stop for allowing the conductor wire to make a transition.

The part where the termination of the conductor wire jumped as indicated by the arrow in FIG. 9, namely, conductor wire m+1ₛ at the beginning of m+1st layer is placed becomes the part where the conductor wire is placed stepwise as ascending treatment or descending treatment is performed, of conductor wire m forming the mth layer, namely, the part surrounded by three conductor wire lines m₁, m₂, and m₃.

Thus, the conductor wire m+1ₛ at the termination of the jumped conductor wire is easily positioned according to the conductor wire lines m₁, m₂, and m₃.

Therefore, to form a motor component using the core component of the invention, the conductor wire passed by wire jump treatment can be placed more reliably at any desired position and winding shift accompanying the transition of the conductor wire caused by the wire jump treatment can be decreased.

In the core component of the invention, the step faces are made parallel to virtual face v produced by the outer shape of the storage section, whereby the layer m is placed on the same line and parallel with the virtual face v and space S having height H for allowing one conductor wire to be stored is provided between conductor wire m₂, m₃, m₄, m₅ . . . not forming the outermost layer, of the layer m and the virtual face v.

The layer m+1 can be easily formed by winding the conductor wire so as to fill in the space S. The conductor wire forming the outermost layer can be easily aligned on the same line and is placed parallel to the virtual face v.

Therefore, the core component of the invention is excellent in windability of the conductor wire and a coil can be formed comparatively easily.

If the core component of the invention is used to form a coil as described above, since the step faces forming the outer peripheral surface of the tooth are provided so as to be parallel with the virtual face produced by the outer shape of the storage section, each layer placed on the step faces during the winding aligns on the same line and is placed parallel with the virtual face and the outermost layer forming the outer shape of the coil is also aligns on the same line and is placed parallel with the virtual face.

The outer shape of the coil provided by winding the conductor wire on the core component of the invention having such step faces becomes a smooth shape with no step.

Thus, with the motor component using the core component of the invention, the dead space can be decreased to effectively use the storage section and the space factor can be enhanced and heat dissipation of the heated coil can also be enhanced.

In FIG. 9, the arrow shows the move state of the conductor wire passed by wire jump treatment; in the figure, the conductor wire is jumped from the left, but may be jumped from the right.

In FIG. 9, ◯ denotes conductor wire and character shown therein denotes the number of the layer to which the conductor wire part belongs.

In contrast to the core component of the invention, in the core 100 in the related art shown in FIG. 7 (B), for example, if winding a conductor wire is started at the end part of the outer peripheral piece 102, a conductor wire 201 is jumped as indicated by the arrow in FIG. 7 (B) from the end part of the fifth layer to the end part of the sixth layer.

The beginning of the jumped conductor wire 201 does not exist in the end part of the outer peripheral piece 102 or the end part of the inner peripheral piece 103 as abutment stop and is positioned in an intermediate part of the slot 104.

The termination of the jumped conductor wire 201 is also positioned in an intermediate part of the slot 104 and a positioning device or the like does not exist.

In the wire jump treatment, the conductor wire is jumped largely and thus a comparatively large force acts in the winding direction of the conductor wire and becomes larger as one layer and the following layer are more distant from each other.

In the core 100 in the related art, the conductor wire is not stable at the beginning and the termination of the jumped conductor wire and the conductor wire is hard to place at any desired position and winding shift (winding disorder) is easily caused to occur because of the acting force accompanying the wire jump treatment. As the winding shift is caused to occur, in the core 100 in the related art, the conductor wire cannot exactly be wound, resulting in a decrease in the space factor.

To prevent winding shift, when the conductor wire is moved in performing wire jump treatment, it is considered that the core rotation speed is decreased, in which case it takes time in wire winding work.

The core may be stopped and the conductor wire may be forcibly deformed with a separately provided jig, etc., before it is wound in some cases.

In the case, the core is detached from and attached to a winder for each wire jump treatment and thus it takes time.

Thus, the core in the related art involves many defects caused by the wire jump treatment.

In the core component of the invention, when wire jump treatment is performed, the conductor wire can be positioned reliably as described above, so that the defects caused by the wire jump treatment can be decreased.

On the other hand, in the core component of the invention with n set to an even number, when a conductor wire is wound, descending treatment, ascending treatment, and wire jump treatment may be skipped and the core component of the invention is excellent in winding workability of the conductor wire as compared with the core component with n set to an odd number described above.

In the core component of the invention with n set to an even number and including the tooth having a step satisfying expression 1 or expression 2, a conductor wire is wound along the outer peripheral surface of the tooth as it starts at the end part of the outer peripheral piece or the end part of the inner peripheral piece and when the conductor wire reaches the end part of the outer peripheral piece, the end part of the inner peripheral piece, or the step, the conductor wire is folded back and is wound so that it is stacked on the layer made of the already wound conductor wire, whereby a coil can be formed.

Therefore, in the core component, the outer shape of the layers formed by the conductor wire wound between the outer peripheral piece and the inner peripheral piece is also a smooth shape with no step during the winding like the final coil outer shape.

Thus, in the core component, to form each layer, the feeder pitches of a winding nozzle can be made equal from the outer peripheral piece side to the inner peripheral piece side, so that not only ascending treatment and descending treatment, but also wire jump treatment is unnecessary.

Thus, since the core component of the invention with n set to an even number does not involve wire jump treatment, the conductor wire can be wound more easily and the winding time can be shortened as compared with not only the core in the related art, but also the core component with n set to an odd number described above.

The core component of the invention with n set to an even number does not impair the appearance and is excellent in beauty because it does not involve any conductor wire handled by wire jump treatment.

Further, the conductor wire passed by wire jump treatment may be projected from the slot without being stored in the slot; if the conductor wire is projected from the slot, gap management between motor components becomes difficult to conduct.

However, since the core component of the invention with n set to an even number does not involve any conductor wire handled by wire jump treatment, the conductor wire wound on the tooth can be all stored in the slot, so that gap management between motor components can be conducted with comparatively good accuracy.

In addition, the core component of the invention with n set to an even number can also eliminate the need for wire jump treatment when end treatment of the wound conductor wire is performed.

Usually, the end part of the wound conductor wire is placed at the end part of the outer peripheral piece or the end part of the inner peripheral piece for treatment. Therefore, if the wound conductor wire is positioned in an intermediate part of the slot, the conductor wire needs to be passed to move the end part to the end part of the outer peripheral piece or the end part of the inner peripheral piece to perform end treatment.

In contrast, in the core component of the invention with n set to an even number, winding the conductor wire can be terminated in the end part of the outer peripheral piece or the end part of the inner peripheral piece and thus wire jump treatment to perform end treatment is not required.

The number of steps provided from the outer peripheral piece side to the inner peripheral piece side may be selected appropriately in response to the size of the motor component, any desired motor characteristic, etc., so as not to decrease the capacity of the storage section as much as possible; it may be one or may be two or more.

To provide two or more steps, the spacing between the adjacent steps may be selected appropriately in response to the size of the tooth, the size of the storage section so as not to decrease the capacity of the storage section as much as possible.

To provide two or more steps, the heights of the steps may be made equal or may be made different.

When the number of steps is N, N+1 step faces are formed on the outer peripheral surface of the tooth formed with such steps.

If the outer peripheral surface of the tooth formed with steps is made a slope inclined so as to cross the coil center axis described above, the step faces are made equal in inclination angle.

This means that the step faces produced for one slope are made parallel.

The step faces are formed so as to become parallel with the virtual face forming the outer shape of the storage section described above.

The size of each step face may be selected appropriately in response to the size of the motor component, the number of conductor wires to be wound at a time, etc.

To wind a plurality of conductor wires side by side at a time, if the size of each step face is provided so as to become a natural number multiple of the number of the conductor wires to be wound, it is easy to conduct winding work of the core component.

If the size of each step face is adjusted so that as many conductor wires as a natural number multiple of the number of the conductor wires to be wound at a time are placed, it is easy to conduct winding work because the ascending treatment, the descending treatment, and the layer change treatment can be performed every as many conductor wires as the number of the conductor wires to be wound at a time.

If the tooth is shaped like a square pyramid frustum and has a width narrowing from the outer peripheral piece side to the inner peripheral piece side in the transverse cross section, preferably the step is provided so as to rise from the outer peripheral piece side to the inner peripheral piece side in the transverse cross section.

On the other hand, preferably a step is provided so as to lower from the outer peripheral piece side to the inner peripheral piece side in the longitudinal cross section.

That is, if the four faces forming the tooth, specifically, a pair of faces placed on the coil end side and a pair of faces placed on the coil side are formed with a step, preferably the faces placed on the coil end side are formed with a step so as to rise from the outer peripheral piece side to the inner peripheral piece side (so as to ascend a staircase) and the faces placed on the coil side are formed with a step so as to lower from the outer peripheral piece side to the inner peripheral piece side (so as to descend a staircase).

The steps are thus provided, whereby the core component can be more miniaturized and by extension a motor can be miniaturized.

For example, a core component is considered wherein a tooth is formed so that when the tooth is cut taken so as to be orthogonal to the coil center axis, the cross-sectional area (magnetic path area) becomes equal and a step is formed so as to lower from the outer peripheral piece side to the inner peripheral piece side in the transverse cross section.

The width of the inner peripheral piece side becomes narrower than that of the outer peripheral piece side in the transverse cross section of the core component.

Therefore, in the core component, the magnetic path on the inner peripheral piece side becomes short in the transverse cross section and thus to equal the magnetic path area, the tooth needs to be formed so that the magnetic path on the inner peripheral piece side becomes long in the longitudinal cross section.

That is, the width (axial length) on the inner peripheral piece side needs to be made longer in the longitudinal cross section; to come to the point, the width on the inner peripheral piece side of the face on the coil side needs to be made long and the inner peripheral piece side of the face on the coil end side needs to be projected outward.

The same thing can be said for a core component formed with a step so as to rise from the outer peripheral piece side to the inner peripheral piece side in the longitudinal cross section.

The core component with the magnetic path area made uniform can improve torque as compared with a core component with the magnetic path area not made uniform.

Therefore, if an attempt is made to obtain the same torque, the core component with the magnetic path area made uniform can be made smaller.

Therefore, such a core component can contribute to miniaturization of a motor.

To form a tooth with a step, angle θ formed by a joint face joining the two step faces producing the step and an extension face of the lower step face (which will be hereinafter called step angle) may be set to 90°, but the joint face is inclined relative to the step faces, whereby the space factor can be more enhanced.

Specifically, preferably the step angle is set to 60′ or less. If two step faces Fd and Fu and a joint face Fc are provided so as to be orthogonal, namely, step angle θ₁ is set to 90° as shown in FIG. 10, dead space Sd may occur between the joint face Fc and a conductor wire 200′ as shown in FIG. 10 (A).

However, if step angle θ2 is set to 60° as shown in FIG. 10 (B), a gap into which one conductor wire (conductor wire indicated by the thick dotted line in FIG. 10 (B)) can be fitted is provided between a conductor wire 200″ placed near to the joint face Fc and the joint face Fc, and a conductor wire is placed in the gap, whereby the dead space can be decreased.

Thus, the core component of the invention formed with the step satisfying the specific step angle mentioned above can enhance the space factor.

However, some shift is possible depending on the dimensional accuracy of the core component and the dimensional accuracy of the conductor wire and thus if the step angle is set to 60°, it is feared that the conductor wire may be unable to enter the gap, may jump from between the conductor wire 200″ and the joint face Fc, and may swell.

Therefore, to provide the gap with a margin, preferably the step angle θ is set to 60° or less; it is proper to set the step angle to about 55°.

The corner produced by the joint face and the higher step face may be rounded.

This means that the corner of the step may be shaped like R. To use a conductor wire including an insulating coating of enamel, etc., if the corner of the step is made sharp, it is feared that the insulating coating may come in contact with the corner and may peel off.

Therefore, preferably the corner of the step is rounded for preventing degradation of insulating properties.

The size of R may be selected appropriately.

The outer peripheral surface (step face) of the tooth may be formed with a groove into which the conductor wire is fitted.

The groove is provided, whereby positioning of the conductor wire with respect to the tooth can be performed stably and winding shift can be decreased.

The shape of the groove may be any if it is a shape for allowing the conductor wire to be positioned and not hindering winding work.

For example, a plurality of projections may be provided so as to use a groove produced between the projections.

In the core component of the invention described above, the tooth, the outer peripheral piece, and the inner peripheral piece are formed in one piece using a magnetic material.

As the magnetic material, for example, an iron family material, more specifically steel of silicon steel, etc., can be named; it is advisable to form the core component of the invention using a plate material or powder made of such a magnetic material.

To form the core component using a plate material, for example, a plate material made of a magnetic material can be cut like a letter T and a plurality of obtained T-shaped plates can be deposited to form a core component shaped like a letter T in the transverse cross section and the longitudinal cross section.

To use a plate material, preferably a plate material including an insulating coating on the surface is used or when plates are deposited, an insulating member is placed between the adjacent plate materials so that a loss involved in occurrence of an eddy current can be decreased.

To use a plate material, an obtained core component is excellent in strength and is preferable.

On the other hand, to form the core component using powder, for example, powder is filled into a mold of a predetermined shape and is pressed, whereby the core component can be formed.

To use powder, the core component of a complicated shape can be easily formed in one piece.

Can be named as the core component of a complicated shape is a core component wherein a step is provided over all faces of a tooth so that when the cross section of the tooth is taken so as to cross the coil center axis, the cross-sectional area becomes equal, more specifically, for example, a core component of a shape wherein the tooth is shaped like a square pyramid frustum and the width narrows from the outer peripheral piece side to the inner peripheral piece side in the transverse cross section and the width narrows from the inner peripheral piece side to the outer peripheral piece side in the longitudinal cross section.

To use powder, if an insulting material is further mixed with powder of a magnetic material and each powder surface is formed with an insulating coating, the electric resistance of a formed pressed powder compact can be increased and the loss involved in occurrence of an eddy current can be decreased.

As the insulating material, for example, an inorganic material of phosphate family, an organic material of polyimide, polyamide, etc., can be named.

The core component of the invention may be formed of the magnetic material described above; it may also be made up of a core part made of a magnetic material and an insulator placed on the outer periphery of the core part and made of an insulating material.

The insulator usually is placed to insulate the coil and the core part stored in the slot. Therefore, also in the invention, to include the insulator, preferably it is formed so as to cover at least the outer periphery of the part corresponding to the storage section in the core part.

At this time, the actual storage section is formed by the insulator. Of course, the insulator may be formed so as to cover all periphery of the core part.

To include the insulator, both the core part and the insulator may have the above-described step and groove.

That is, the core part and the insulator may be made similar or may be made non-similar by providing only the insulator with a step and a groove without providing the core part with a step or a groove.

As the insulating material to form the insulator, for example, a resin such as PPS (Poly Phenylene Sulfide) or LCP (Liquid Crystal Polymer) can be named. An inorganic filler may be added to such a resin.

When a motor component is used, the coil is heated and thus the heat is released to the outside through the core component. The core component of the invention having the tooth including a step is excellent in heat dissipation as the heat of the coil can be well transferred to the core component because the contact area between the core component and the coil is large as compared with the core in the related art. Further, the insulator is formed of a resin containing an inorganic filler, so that heat dissipation can be more improved.

As the inorganic filler, for example, an insulating material of glass (silicon dioxide), alumina (aluminum oxide), titanium oxide, etc., can be named.

More specifically, fibrous glass several μm in diameter and several hundred μm in length can be named and disk-like (tip-like) alumina or titanium oxide several μm to several ten μm in diameter can be named.

The addition amount may be selected appropriately. Preferably, such an insulator has a structure wherein split pieces are combined into one piece, so that it can be easily placed on the outer periphery of the core part.

In the motor component of the invention including the described motor core component and the coil made of the wound conductor wire stored in the storage section of the core component, the outer shape of the coil placed at least on the face having a step in the core component becomes a smooth shape with no step.

Particularly, a step is provided over all faces of the tooth of the core component, whereby the whole outer shape of the coil becomes a smooth shape with no step. The step faces are made parallel with the virtual face, whereby the outer shape of the coil becomes parallel with (or equal to) the virtual face forming the outer shape of the storage section.

Thus, in the motor component of the invention, the dead space can be decreased and the space factor of the conductor wire in the storage section can be enhanced than was previously possible.

As the dead space is decreased, the motor component of the invention can release heat of the heated coil more efficiently. In the invention, the conductor wire forming the outer shape of the coil is the conductor wire producing the layers forming the coil and does not contain the conductor wire passed by the wire jump treatment described above.

Therefore, in the invention, projecting the conductor wire passed by the wire jump treatment from the storage section is allowed. If n is set to an even number, wire jump treatment is skipped as described above and thus all conductor wire forming the coil is stored in the storage section.

The motor component of the invention described above is provided by providing the above-described core component of the invention, normally winding a conductor wire along the outer periphery of the tooth between the outer peripheral piece and the inner peripheral piece starting at the outer peripheral piece end part or the inner peripheral piece end part of the tooth of the core component, and terminating winding the conductor wire so that the conductor wire placed on the outermost side align on the same line. The winding is started at the outer peripheral piece end part or the inner peripheral piece end part, so that it is made possible to draw out the beginning end of the conductor wire to the outside.

As the conductor wire is normally wound, the number of turns of the conductor wire can be increased and the space factor of the conductor wire can be enhanced. Winding the conductor wire is started and when the conductor wire reaches a step, it is folded back or ascending treatment or descending treatment is performed as described above. Winding the conductor wire is started and when the conductor wire arrives at the outer peripheral piece end part (opposed face to the inner peripheral piece) or the inner peripheral piece end part (opposed face to the outer peripheral piece), the conductor wire is folded back and the layer is changed (layer change treatment). At this time, the outer peripheral piece and the inner peripheral piece are provided so that the opposed face of the outer peripheral piece to the inner peripheral piece and the opposed face of the inner peripheral piece to the outer peripheral piece are orthogonal to the outer peripheral surface (step face) of the tooth, so that winding shift is prevented and the conductor wire is easily advanced to the next layer.

The conductor wire is wound so that the conductor wire placed on the outermost periphery side does not become stepwise. If n is set to an odd number, wire jump treatment is performed as required.

A predetermined number of the motor components of the invention formed as described above can be set on the ring-like section to make up a motor.

As the setup motor components, the conductor end parts to produce the coil may be connected as a concentrated winding structure or a lap winding structure.

Such a motor can be used as an outer stator type motor and an inner stator type motor, for example.

### ADVANTAGES OF THE INVENTION

The above-described core component of the invention can decrease the dead space and can enhance the space factor of the conductor wire in the storage section as compared with the core in the related art.

Therefore, the motor component of the invention including the core component of the invention has a higher space factor of the conductor wire as compared with the motor component in the related art.

The motor component of the invention is excellent in heat dissipation because the heat of the coil heated by energization is easily released as the dead space is decreased.

Further, in the motor component of the invention, the outer shape of the coil is a smooth shape rather than a stepped shape and thus when the motor components are assembled into a motor, gap management between the adjacent motor components is easy to conduct and a motor excellent in gap accuracy can be provided.

Further, in the core component of the invention, if n is set to an odd number, the space factor of the conductor wire can be more enhanced; if n is set to an even number, excellent winding workability of the conductor wire is provided.

Particularly, if n is set to an even number, the need for wire jump treatment required in the related art can be eliminated. Thus, using the core component of the invention, there can be provided a motor component which not only improves workability, but also is excellent in beauty because a conductor wire passed by wire jump treatment does not exist.

### BRIEF DESCRIPTION OF THE DRAWINGS

FIG. 1 (A) is a perspective view to schematically show a core component of the invention and (B) is a top view to show a tooth part in a state in which the core component shown in (A) is seen from the direction indicated by the arrow.

FIG. 2 (A) is a transverse sectional view of a motor component of the invention including a core component having a step of height D×(√3/2) and (B) is an enlarged view to describe the step portion.

FIG. 3 is a schematic representation to describe a state in which a conductor wire is wound on a core component.

FIG. 4 is a schematic representation to describe a procedure of forming the motor component of the invention including a core component having a step of height D×(√3/2), and shows the transverse cross section of the right portion.

FIG. 5 is a transverse sectional view of a motor component of the invention including a core component having a step of height D X (√3/2)×2.

FIG. 6 is a schematic representation to describe a procedure of forming the motor component of the invention including a core component having a step of height D×(√3/2)×2, and shows the transverse cross section of the right portion.

FIG. 7 (A) is a perspective view to schematically show a separation type core in a related art and (B) is a transverse sectional view of a motor component in the related art including the separation type core in the related art.

FIG. 8 is a schematic representation to describe a stack state of conductor wire circular in transverse cross section.

FIG. 9 is a schematic representation to describe a conductor wire state when wire jump treatment is performed in winding a conductor wire on the outer peripheral surface of the tooth of the core component of the invention to form a coil.

FIG. 10 is a schematic representation to describe a state in which a conductor wire is placed on the outer periphery of the tooth of the core component of the invention and shows a step portion on an enlarged scale; (A) shows the case where the step angle is 90° and (B) shows the case where the step angle is 60°.

### DESCRIPTION OF REFERENCE NUMERALS

10, 20 Core component, 10c, 20c Core part, 10i, 20i Insulator, 11, 21 Tooth, 11a, 11b, 21a, 21b Step face, 11A First trapezoidal face, 11B Second trapezoidal face, 11c, 21c Joint face, 12, 22 Outer peripheral piece, 12a, 13a, 22a, 23a Opposed face, 13, 23 Inner peripheral piece, 14, 24 Storage section, 14a, 24a Virtual face, 25 Projection, 100 Core, 100c Core part, 100i Insulator, 101 Tooth, 101a First trapezoidal face, 101b Second trapezoidal face, 102 Outer peripheral piece, 102a, 103a Opposed face, 103 Inner peripheral piece, 104 Storage section, 105 Dead space

200 Conductor wire, 300 Ring-like section, 400 Nozzle

### BEST MODE FOR CARRYING OUT THE INVENTION

Embodiments of the invention will be discussed based on the accompanying drawings.

### First Embodiment

### When N is an Odd Number

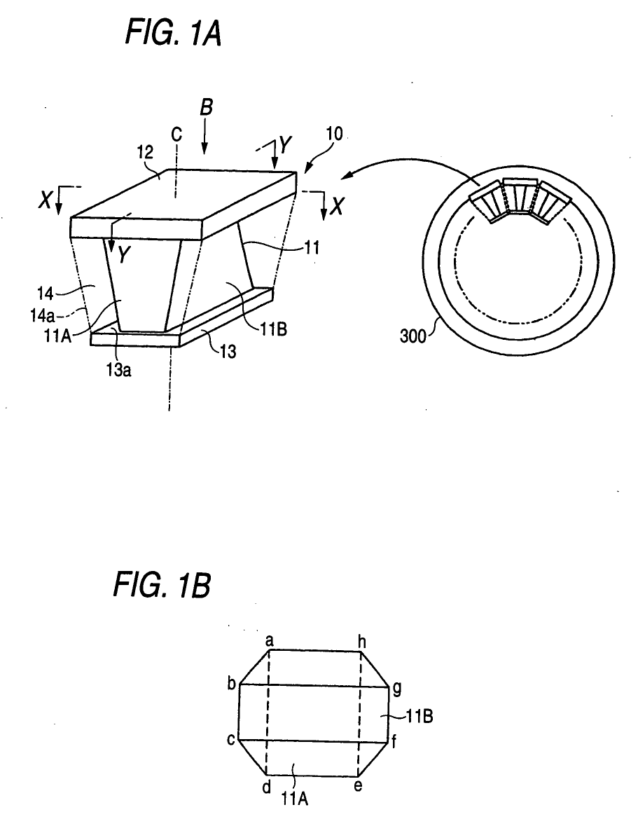

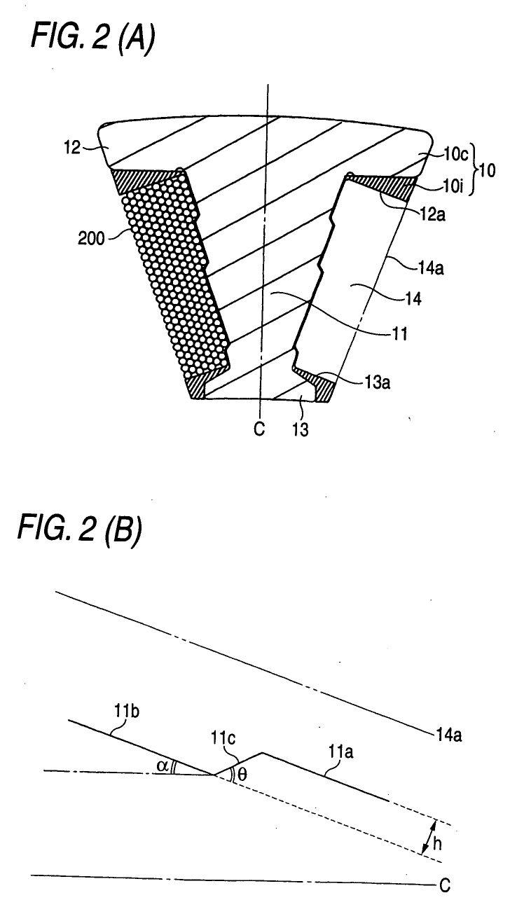

FIG. 1 (A) is a perspective view to schematically show a core component of the invention and (B) is a top view to show a tooth part in a state in which the core component is seen from above (A) and FIG. 2 (A) is a transverse sectional view of a motor component of the invention and (B) is an enlarged view of a step portion.

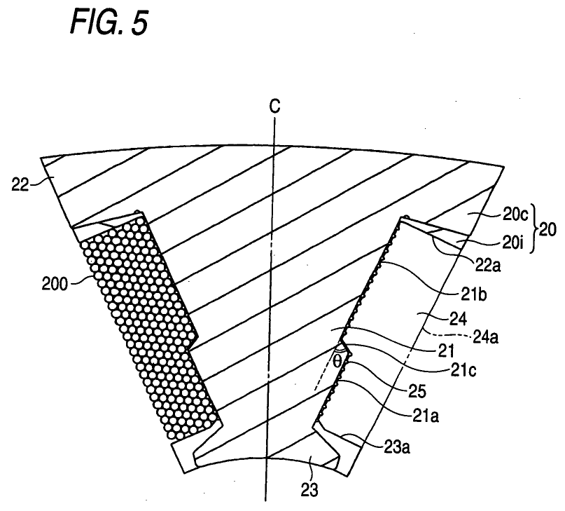

In FIG. 1, the step is not shown. In FIG. 2 (A), the conductor wire placed in the right half is not shown; in fact, however, a conductor wire also exists in the right half as in the left half. This point also applies to FIG. 5 described later.

The motor component of the invention includes a motor core component 10 made of a magnetic material and a coil having a conductor wire 200 wound on the core component 10.

Such motor components are placed on a ring-like part 300 in combination so as to form an annular shape for use as a motor stator.

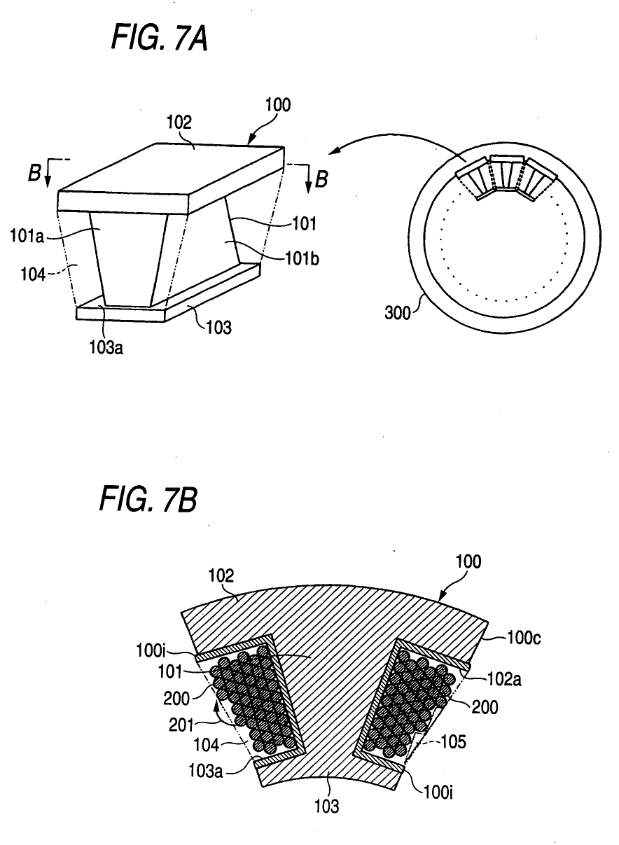

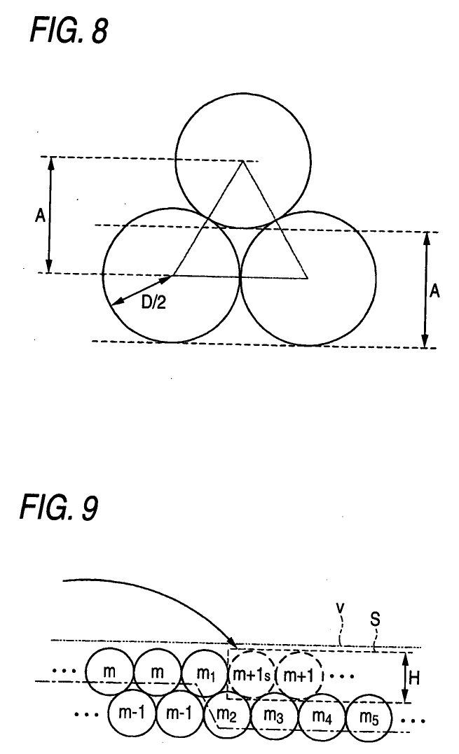

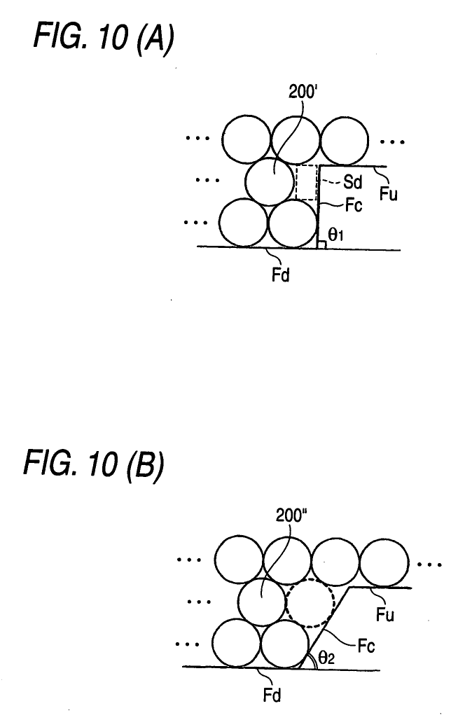

The basic configuration is similar to that of the motor component in the related art shown in FIG. 7. The motor component of the invention is most characterized by the shape of the core component 10; specifically it is characterized in that it includes steps having a specific height on the outer peripheral surface of a tooth 11 on which the conductor wire 200 is wound and that the outer peripheral surface of the tooth 11 (step faces 11a and 11b producing a step) is made parallel to a virtual face 14a producing the outer shape of a storage section 14 for storing the coil.

A description is given below centering on the motor component 10:

The basic configuration of the core component 10 is similar to that of the core component in the related art shown in FIG. 7.

Specifically, the core component includes the tooth 11 on which a conductor wire is wound, an outer peripheral piece 12 provided on one end side of the tooth 11 (face bcfg side in FIG. 1 (B)) and placed on the outer periphery side when the core component is placed on the ring-like part 300 and is assembled as a part of a motor, and an inner peripheral piece 13 provided on an opposite end side of the tooth 11 (face adeh side in FIG. 1 (B)) so as to be opposed to the outer peripheral piece 12 and placed on the inner periphery side when the core component is assembled as a part of a motor, as shown in FIG. 1.

The outer peripheral piece 12 and the inner peripheral piece 13 are provided with parts projected to the outside of the tooth 11 so that the transverse cross section and the longitudinal cross section become shaped each like a letter T.

The space surrounded by the outer peripheral surface of the tooth 11, an opposed face 12a of the outer peripheral piece 12 to the inner peripheral piece 13, and an opposed face 13a of the inner peripheral piece 13 to the outer peripheral piece 12 forms the coil storage section 14.

The face made up of lines connecting the end parts of the outer peripheral piece 12 and the end parts of the inner peripheral piece 13 becomes the virtual face 14a producing the outer shape of the storage section 14.

In the embodiment, a core part 10c made of a magnetic material and an insulator 10i made of an insulating material make up the core component 10.

The core part 10c is formed by filling magnetic material powder into a mold and pressing and molding the powder so that the transverse cross section and the longitudinal cross section become shaped each like a letter T.

The insulator 10i is formed of a resin of PPS, LCP, etc., and is provided for insulating the core part 10c and the conductor wire.

Therefore, the insulator 10i is placed so as to cover the part where the conductor wire comes in contact with the core part 10c, specifically the part corresponding to the storage section in the core part 10c.

Therefore, in the embodiment, the insulator 10i forms the actual storage section 14.

In the embodiment, the part of the insulator 10i placed in the tooth in the core part 10c is formed like a thin shape following the outer shape of the core part 10c and the parts of the insulator 10i placed on the opposed face to the outer peripheral piece in the core part 10c and placed on the opposed face to the inner peripheral piece in the core part 10c are formed each like a thick shape.

Both the opposed faces 12a and 13a made by the insulator 10i are provided so as to be orthogonal to the outer peripheral surface of the tooth 11.

The insulator 10i has a structure wherein a pair of split pieces is combined into one piece, and can be easily placed in the core part 10c.

The tooth 11 is shaped like a square pyramid frustum having four slopes cfed, bgha, bcda, and gfeh as shown in FIG. 1 (B) and is made up of a pair of first trapezoidal faces 11A (faces cfed and bgha in FIG. 1 (B)) each with the width narrowing from the outer peripheral piece side to the inner peripheral piece side in the transverse cross section (corresponding to the x-x cross section in FIG. 1) and a pair of second trapezoidal faces 11B (faces bcda and gfeh in FIG. 1 (B)) each with the width widening from the outer peripheral piece side to the inner peripheral piece side in the longitudinal cross section (corresponding to the y-y cross section in FIG. 1).

The side where the first trapezoidal face 11A is placed is called the coil end side and the side where the second trapezoidal face 11B is placed is called the coil side.

When the motor components are placed on the ring-like part 300 and are assembled into a motor, the face placed on the coil end side (here, the first trapezoidal face 11A) of one motor component is not opposed to an adjacent motor component and is seen from the front as shown in FIG. 1.

When the motor components are placed on the ring-like part 300 and are assembled into a motor, the face placed on the coil side (here, the second trapezoidal face 11B) of one motor component is opposed to an adjacent motor component and is not seen from the front.

Each of the step faces 11A and 11B is sloped at an inclination angle α≈10° with respect to the center axis of the coil placed on the tooth 11 (which will be hereinafter called coil center axis) C (for the inclination angle α, see FIG. 2 (B)).

As the tooth 11 is thus formed with the slopes, the capacity of the storage section can be increased and the widths of the adjacent faces are changed alternately, whereby when the cross section of the tooth is taken so as to be orthogonal to the coil center axis C, the cross-sectional area (magnetic path area) can be made substantially equal.

Such a core component 10 is used, whereby a motor component having a uniform magnetic characteristic from the outer peripheral piece side to the inner peripheral piece side can be provided.

Further, to enhance the space factor of the conductor wire in the storage section, the tooth 11 has the outer peripheral surface formed with a plurality of steps as shown in FIG. 2, and for every step, height (step height) h between two faces producing a step (the step faces 11a and 11b) satisfies {D×(√3/2)}×n (expression 1) where D is the diameter of the conductor wire 200 and n is a natural number. In the embodiment, a round wire circular in the transverse cross section having the diameter D is used as the conductor wire 200.

The step is provided so that the step faces 11a and 11b are parallel to the virtual face 14a.

In the embodiment, three steps are provided and the height of each step is provided so as to satisfy expression 1 mentioned above (n=1).

The three steps are provided so as to become higher from the outer peripheral piece side to the inner peripheral piece side in the transverse cross section and are provided so as to become lower from the outer peripheral piece side to the inner peripheral piece side in the longitudinal cross section although not shown.

Further, the tooth 11 is formed with the steps over all faces so that when the cross section of the tooth 11 is taken so as to be orthogonal to the coil center axis C, the cross-sectional area (magnetic path area) becomes equal.

That is, as shown in FIG. 2, the steps are provided not only on the coil side, but also on the coil end side.

According to the configuration, the core component 10 can form a motor component having a uniform magnetic characteristic from the outer peripheral piece side to the inner peripheral piece side.

As the tooth is formed so that the magnetic path area becomes uniform, the torque of the core component 10 improves. Therefore, if an attempt is made to obtain the same torque as a core component having a nonuniform magnetic path area, the core component 10 can be made smaller.

Thus, to use the core components 10, a smaller-sized motor can be provided.

The described core component 10 is used, whereby if a conductor wire is normally wound on the outer periphery of the tooth 11 to form a coil, the conductor wire forming the outer shape of the coil is placed on the same line in the transverse cross section and the longitudinal cross section.

This line becomes parallel with the virtual face 14a producing the outer shape of the storage section 14. That is, since the outer shape of the coil placed on the core component 10 does not become step-wise unlike the motor component in the related art shown in FIG. 7, the motor component including the core component 10 is free of a stepped dead space in the storage section 14 as shown in FIG. 2.

Therefore, the motor component including the core component 10 makes it possible to make the most of the storage section 14 and enhance the space factor of the conductor wire 200 than was previously possible.

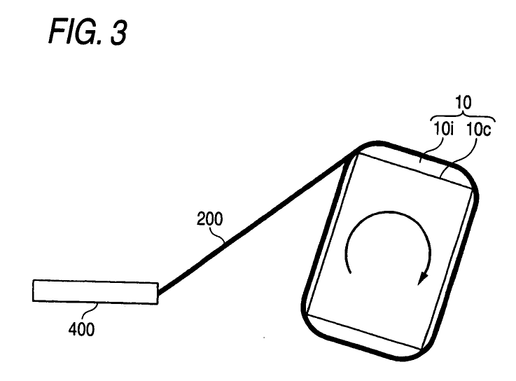

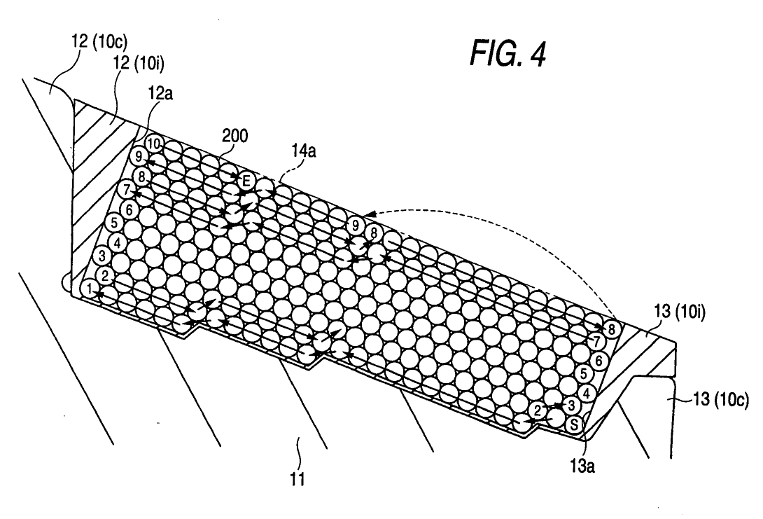

A procedure of winding the conductor wire 200 on the core component 10 to form a motor component will be discussed. FIG. 3 is a schematic representation to describe a state in which a conductor wire is wound on a core component, and FIG. 4 is a transverse sectional view of a part of the motor component of the invention on an enlarged scale, and shows only the right half.

Each digit shown in the conductor wire denotes the number of the layer to which the conductor wire part belongs. First, the above-described core component 10 is provided. In the embodiment, the core component 10 includes the insulator 10i as described above and thus the insulator 10i is placed on the outer periphery of the tooth of the core part 10c to form the core component 10.

Next, the core component 10 is set on a coil winder (not shown) and while the core component 10 is rotated, a conductor wire 200 supplied from a winding nozzle 400 is wound as shown in FIG. 3.

In the embodiment, one conductor wire is supplied from the winding nozzle and is wound on the core component 10.

In the embodiment, winding the conductor wire is started at an end part of the inner peripheral piece 13 (is started at the part of conductor wire 200 indicated by “S” in FIG. 4) and normal winding is executed.

A first layer is formed by winding the conductor wire 200 along the outer peripheral surface (step face) of the tooth 11 so as to descend from the higher step side (inner peripheral piece side) to the lower side (outer peripheral piece side) on the face of the coil side and so as to ascend from the lower step side (inner peripheral piece side) to the higher side (outer peripheral piece) on the face of the coil end side.

When a step is reached, descending treatment of adjusting the winding nozzle is performed to descend the step as indicated by the short downward arrow in FIG. 4 is repeated for advancing winding the conductor wire 200 from the inner peripheral piece 13 to the outer peripheral piece 12.

In the embodiment, the descending treatment is performed three times to form the first layer.

The first layer placed on the tooth 11 is placed so as to be parallel with the virtual face 14a following the step face because the step face of the outer peripheral surface of the tooth 11 is placed so as to be parallel with the virtual face 14a.

When the conductor wire 200 of the first layer reaches the end part of the outer peripheral piece 12, layer change treatment is performed to form the next layer (second layer).

Specifically, the conductor wire 200 is folded back so that the conductor wire 200 of the second layer is placed in the gap produced by the two lines of the conductor wire 200 nearest to the outer peripheral piece 12, of the conductor wire 200 producing the first layer.

In the embodiment, the step face and the opposed face 12a, 13a are provided so as to be orthogonal to each other as described above, so that the opposed faces 12a and 13a can be used as abutment stops and folding back can be easily conducted.

As the folding back is conducted, the first layer and the second layer become opposite in the winding direction.

The second layer is formed by winding the conductor wire 200 so as to ascend from the lower step side to the higher side in an opposite manner to that of the first layer.

When the conductor wire 200 reaches a step, the nozzle is adjusted and ascending treatment is performed repeatedly for advancing winding the conductor wire 200 from the outer peripheral piece 12 to the inner peripheral piece 13.

In the embodiment, the ascending treatment is performed three times to form the second layer.

The second layer placed on the first layer is placed so as to be parallel with the virtual face 14a following the first layer placed so as to be parallel with the virtual face 14a.

Other layers are formed by repeating the descending treatment, the ascending treatment, and the layer change treatment in a similar manner to that of the first and second layers.

Each layer is placed so as to be parallel with the virtual face 14a following the layer below that layer. That is, each layer is placed so as to be parallel with the virtual face 14a during the coil forming.

The conductor wire raised in the gap produced by the two lines of the conductor wire 200 at the position nearest to the inner peripheral piece 13 by performing the third ascending treatment in forming the second layer becomes the beginning part of the conductor wire 200 to form a third layer, and descending treatment and ascending treatment are repeated twice in forming each of the third to eighth layers.

A part of the conductor wire 200 to form the eighth layer (conductor wire 200 placed from the middle of the tooth 11 to the inner peripheral piece 13), of the conductor wire wound on the core component 10 becomes the conductor wire forming the outer shape of the coil.

When the conductor wire 200 as the conductor wire at the termination of the eighth layer reaches the inner peripheral piece 13, to form a ninth layer, wire jump treatment of moving the conductor wire 200 to the middle of the tooth 11 as indicated by the dashed line arrow in FIG. 4 is performed.

When the wire jump treatment is performed, since the beginning of the conductor wire to be jumped reaches the inner peripheral piece 13, it can be easily passed to the outer peripheral piece side using the inner peripheral piece 13 as abutment stop.

A space having a height to such an extent that one line of the conductor wire 200 can be placed is open between the conductor wire forming the eighth layer and the virtual face 14a before the ninth layer is formed, and three conductor wires of the eighth layer existing in the end part of the space are used as abutment stop of the termination of the conductor wire to be jumped, whereby the termination of the conductor wire can be positioned easily.

Therefore, in the core component, wire jump treatment can be performed easily and winding shift caused by wire jump treatment is also hard to occur. The termination of the jumped conductor wire also becomes the beginning conductor wire of the ninth layer.

After the wire jump treatment is performed, subsequently the conductor wire is wound so as to fill in the space from the middle of the tooth 11, so that a part of the ninth layer (the portion as the outermost layer forming the outer shape of the coil) can be formed easily.

The conductor wire of the ninth layer placed so as to fill in the space is placed so as to align on the same line as the conductor wire of the eighth layer forming the outer shape of the coil.

One descending treatment is performed midway, the conductor wire is wound until the conductor wire 200 reaches the outer peripheral piece 12, forming the ninth layer is terminated, and the conductor wire 200 is folded back at the outer peripheral piece 12 to form a tenth layer.

Before the tenth layer is formed, a space having a height to such an extent that one line of the conductor wire 200 can be placed is open between the conductor wire forming the ninth layer and the virtual face 14a as before formation of the ninth layer described above. The conductor wire is wound so as to fill in the space, whereby the tenth layer can be formed easily. The tenth layer terminates at the middle of the tooth 11 (the conductor wire 200 indicated by “E” in FIG. 4 is the conductor wire of the winding termination). The conductor wire forming the tenth layer is placed so as to align on the same line as a part of the conductor wire of the eighth layer and a part of the conductor wire of the ninth layer forming the outer shape of the coil, and forms the outer shape of the coil.

The line made up of the parts of the conductor wire is placed parallel with the virtual face 14a.

The conductor wire 200 is thus wound on the above-described core component 10 having the steps as described above, whereby a coil having a smooth outer shape with no step can be formed.

The conductor wire of the outermost layer forming the coil is placed parallel with the virtual face 14a, so that the storage section 14 of the motor component can be used efficiently and the space factor can be enhanced.

The coil is formed by winding a conductor wire of one continuous length.

In the embodiment, the case where one conductor wire is wound at a time has been described, but two or more conductor wires may be wound collectively.

To wind a plurality of conductor wires at a time, the conductor wires may be supplied to a core component so that they align side by side.

To wind a plurality of conductor wires on a core component at a time, if the size of each step face is adjusted so that as many conductor wires as a natural number multiple of the number of the conductor wires to be wound at a time are placed, it is easy to conduct the ascending treatment, the descending treatment, and the layer change treatment. This point also applies to a second embodiment described later.

The core component used in the embodiment is shaped like a square pyramid frustum made up of a pair of first trapezoidal faces and a pair of second trapezoidal faces, but may be shaped like a square pyramid frustum made up of a pair of trapezoidal faces and a pair of rectangular faces.

This means that two faces may be slopes and two faces may be faces parallel with the coil center axis.

Further, the core component used in the embodiment has the tool formed with steps over all faces, but the tooth may be formed with steps only on one of the four faces.

At this time, the outer shape of the coil formed on the face formed with steps becomes a smooth shape with no step.

In addition, in the embodiment, the core component including the insulator is used, but no insulator may be included if a conductor wire including an insulating coating is used.

Further, in the embodiment, the core component is formed by powder pressing and molding using magnetic material powder, but may be formed by depositing a plurality of layers of plate material made of magnetic material.

Particularly, to adopt a core component shaped like a square pyramid frustum formed of a pair of trapezoidal faces and a pair of rectangular faces, the core component can be easily formed by depositing layers of plate material made of magnetic material.

The core component using the plate material is more excellent in strength than the core component formed by powder pressing and molding.

These points also apply to the second embodiment described later.

In the core component 10 used in the embodiment, the angle (step angle) θ formed by a face 11c joining the two step faces 11a and 11b producing a step and an extension face of the step face 11b of the lower step (see FIG. 2 (B)) is set to 60°.

The step angle is set to 60°, whereby in the core component 10, a dead space occurring between the joint face 11c and the conductor wire can be decreased and the space factor can be enhanced.

If the step angle θ is set to about 55°, an allowance is produced between the joint face 11c and the conductor wire, so that the conductor wire is easily placed and such a core component is excellent in winding workability.

In the core component 10 used in the embodiment, the corner produced by the joint face 11c joining the two step faces 11a and 11b and the step face is made sharp, but may be rounded.

The core component with the corner rounded can prevent a defect such that if a conductor wire including an insulating coating is used, the insulating coating comes in contact with the corner and peels off, etc.

This point also applies to the second embodiment described later.

Further, in the embodiment, the case where a round wire circular in the transverse cross section is used as the conductor wire has been described, but a flat wire rectangular in transverse cross section may be used.

In this case, the step height may be n×t where t is the thickness of the flat wire and n is a natural number.

This point also applies to the second embodiment described later.

### Second Embodiment

### When N is an Even Number

In the first embodiment, the case where n is an odd number has been described.

In the second embodiment, the case where n is an even number will be discussed.

FIG. 5 is a transverse sectional view of a motor component of the invention.

The basic configuration of the motor component is similar to that of the first embodiment and will not be discussed again in detail. An outline is as follows: The motor component shown in the embodiment is made up of a motor core component 20 and a coil having a conductor wire 200 wound on the core component 20.

The core component 20 includes a step having specific height {D×(√3/2)}×n (D is the diameter of the conductor wire 200) over the full outer peripheral surface of a tooth 21 shaped like a square pyramid frustum on which the conductor wire 200 is wound, namely, on both coil side and coil end side faces, and step faces 21a and 21b producing the step are made parallel to a virtual face 24a forming the outer shape of a storage section 24.

The core component 20 has the transverse cross section and the longitudinal cross section each shaped like a letter T including the tooth 21 on which the conductor wire 200 is wound, an outer peripheral piece 22 provided on one end side of the tooth 21, and an inner peripheral piece 23 provided on an opposite end side of the tooth 21 so as to be opposed to the outer peripheral piece 22.

The tooth 21 is formed so that when the cross section is taken so as to be orthogonal to the coil center axis, the cross-sectional area (magnetic path area) becomes uniform.

The space surrounded by the outer peripheral surface of the tooth 21, an opposed face 22a of the outer peripheral piece 22 to the inner peripheral piece 23, and an opposed face 23a of the inner peripheral piece 23 to the outer peripheral piece 22 forms a coil storage section 24, and the face made up of lines connecting the end parts of the outer peripheral piece 22 and the end parts of the inner peripheral piece 23 becomes a virtual face 24a producing the outer shape of the storage section 24.

The core component 20 is made up of a core part 20c formed by pressing and molding magnetic material powder and an insulator 20i made of an insulating material.

The insulator 20i is formed so as to cover the outer periphery of the storage section in the core part 20c.

In the embodiment, the insulator 20i is formed on the outer peripheral surface with a plurality of projections 25 and the conductor wire 200 is fitted into a groove produced between the projections 25.

According to the configuration, when the conductor wire 200 is wound, the conductor wire 200 can be positioned easily and winding shift of the conductor wire 200 can be prevented.

The core component 20 shown in the embodiment largely differs from that in the first embodiment in the height of the step provided on the outer periphery of the tooth 21 of the core component 20.

In the second embodiment, the height is set to {D×(√3/2)}×2. Also in the embodiment, a round wire circular in the transverse cross section is used as the conductor wire.

In the embodiment, one step is provided. Further, in the embodiment, step angle θ is set to 60°.

The described core component 20 is used, whereby if a conductor wire is normally wound on the outer periphery of the tooth 21 to form a coil, the conductor wire forming the outer shape of the coil is placed on the same line in the transverse cross section and the longitudinal cross section, and this line becomes parallel with the virtual face 24a producing the outer shape of the storage section 24.

Therefore, the motor component including the core component 20 makes it possible to decrease dead space to enhance the space factor of the conductor wire 200 than was previously possible as with the motor component shown in the first embodiment and also improve heat dissipation.

If n is set to an even number in step height {D×(√3/2)}×n like the core component 20 shown in the embodiment, excellent winding workability of a conductor wire is provided as compared with the configuration of the first embodiment.

A procedure of forming a motor component will be discussed.

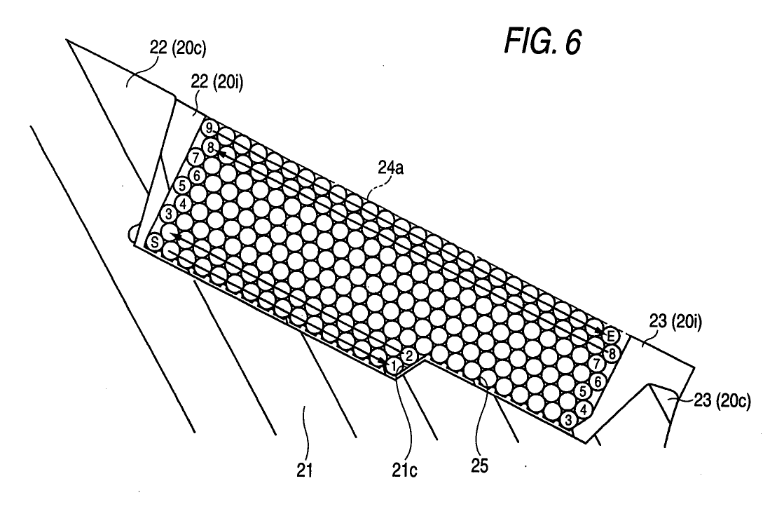

FIG. 6 is a transverse sectional view of a part of the motor component of the invention on an enlarged scale, and shows only the right half. Each digit shown in the conductor wire denotes the number of the layer to which the conductor wire part belongs.

First, the above-described core component 20 is provided. In the embodiment, the core component 20 includes the insulator 20i as described above and thus the insulator 20i is placed on the outer periphery of the tooth 21 of the core part 20c to form the core component 20.

Next, the core component 20 is set on a coil winder (not shown) and while the core component 20 is rotated, a conductor wire 200 supplied from a winding nozzle 400 is wound.

In the embodiment, two conductor wires are supplied at the same time from the winding nozzle and are wound on the core component 20 at the same time.

The two conductor wires are supplied so that they align side by side (two wires align in the traveling direction).

In the embodiment, conductor wire winding is started at an end part of the outer peripheral piece 22 (is started at the part of conductor wire 200 indicated by “S” in FIG. 6) and normal winding is executed.

To form a first layer, conductor wires are wound so that they align on the same line along the outer peripheral surface (step face 21b) of the tooth 21 from the end part of the outer peripheral piece 22 and when the conductor wires reach a joint face 21c jointing the step faces, forming the first layer is complete.

The first layer placed on the tooth 21 is placed so as to be parallel with the virtual face 24a following the step face because the step face of the outer peripheral surface of the tooth 11 is placed so as to be parallel with the virtual face 24a.

Next, layer change treatment is performed to form a second layer. In the layer change treatment, the conductor wires are folded back so that the conductor wires as the beginning conductor wires of the second layer are placed in the gap produced by the conductor wire 200 nearest to the joint face 21c and the joint face 21c.

As the folding back is conducted, the first layer and the second layer become opposite in the winding direction.

To form the second layer, like the first layer, the conductor wires 200 are wound so that the conductor wires 200 align on the same line from the joint face 21c to the outer peripheral piece 22 and when the conductor wires 200 reach the outer peripheral piece 22, layer change treatment is performed to form a third layer.

The second layer placed on the first layer is placed so as to be parallel with the virtual face 24a following the first layer placed so as to be parallel with the virtual face 24a.

After this, when the conductor wires 200 reach the outer peripheral piece 22 and the inner peripheral piece 23, layer change treatment is performed to form each layer.

Each layer is placed so as to be parallel with the virtual face 24a following the layer below that layer.

That is, each layer is placed so as to be parallel with the virtual face 24a during the coil forming.

In the first embodiment described above, to form each layer, the conductor wire is moved so as to ascend and descend a staircase.

However, in the core component of the second embodiment with n being an even number, the conductor wires may be moved so as to align on the same line as described above and need not be moved so as to ascend and descend a staircase.

Therefore, to manufacture a motor component using the core component shown in the second embodiment, ascending treatment and descending treatment become unnecessary.

In the embodiment, the conductor wires 200 to form the ninth layer become the conductor wires forming the outer shape of the coil.

To form the ninth layer, like the third layer, the conductor wires 200 are wound so that the conductor wires 200 align on the same line from the end part of the outer peripheral piece 22 to the end part of the inner peripheral piece 23 and when the conductor wires 200 reach the inner peripheral piece 23, the conductor wire winding is terminated.

The conductor wires are thus wound on the core component shown in the embodiment, whereby the conductor wires placed on the outermost side forming the outer shape of the coil are also aligned on the same line and a coil having a smooth outer shape with no step can be formed.

The conductor wires of the outermost layer forming the coil are placed parallel with the virtual face 24a, so that the storage section 24 of the motor component can be used efficiently and the space factor can be enhanced.

Further, in the core component shown in the embodiment, the conductor wire winding can be terminated at the end part of the inner peripheral piece 23 as described above, so that the need for performing the wire jump treatment as in the first embodiment can be eliminated and the winding work time can be shortened. In addition, in the core component shown in the embodiment, winding the conductor wires can be terminated at the end part of the inner peripheral piece 23 as described above, so that end part treatment of the conductor wires 200 can also be easily conducted and it is also unnecessary to jump conductor wires accompanying the end part treatment.

### INDUSTRIAL APPLICABILITY

The core component of the invention can be used for a motor component forming a part of a motor such as a stator. The motor component of the invention can also be used as a component of the motor.

The motor can be used for an electric automobile, a hybrid automobile, etc. Further, the forming method of the motor component of the invention can be used to manufacture the motor component of the invention described above.

1. A motor core component comprising a tooth with an outer periphery on which a conductor wire is wound, an outer peripheral piece provided on one end side of said tooth and placed on the outer periphery side when said core component is assembled as a part of a motor, and an inner peripheral piece provided on an opposite end side of said tooth so as to be opposed to said outer peripheral piece and placed on the inner periphery side when said core component is assembled as a part of a motor, wherein space surrounded by the outer peripheral surface of said tooth, an opposed face of said outer peripheral piece to said inner peripheral piece, and an opposed face of said inner peripheral piece to said outer peripheral piece is used as a conductor wire storage section, characterized in that
said tooth is formed with a step at least in a part of the outer peripheral surface, that
a height between two step faces producing the step satisfies {D×(√3/2)}×n (where n is a natural number) when the diameter of the conductor wire is D, and that
the step faces and a virtual face forming the outer shape of the storage section are parallel.

2. A motor core component comprising a tooth with an outer periphery on which a conductor wire is wound, an outer peripheral piece provided on one end side of said tooth and placed on the outer periphery side when said core component is assembled as a part of a motor, and an inner peripheral piece provided on an opposite end side of said tooth so as to be opposed to said outer peripheral piece and placed on the inner periphery side when said core component is assembled as a part of a motor, wherein space surrounded by the outer peripheral surface of said tooth, an opposed face of said outer peripheral piece to said inner peripheral piece, and an opposed face of said inner peripheral piece to said outer peripheral piece is used as a conductor wire storage section, characterized in that
said tooth is formed with a step at least in a part of the outer peripheral surface, that
a height between two step faces producing the step satisfies t×n (where n is a natural number) when the conductor wire is a square wire and the thickness thereof is t, and that
the step faces and a virtual face forming the outer shape of the storage section are parallel.

3. The motor core component as claimed in claim 1, characterized in that n is an even number.

4. The motor core component as claimed in claim 1, characterized in that said motor core component comprises a core part made of a magnetic material and an insulator placed on the outer periphery of the core part and made of an insulating material.

5. The motor core component as claimed in claim 1, characterized in that the step is provided over all faces of the outer peripheral surface of said tooth, and that
further the step is provided so that when the cross section of said tooth is taken so as to be orthogonal to the center axis of a coil as the wound conductor wire on said tooth, the cross-sectional area becomes substantially equal.

6. The motor core component as claimed in claim 5, characterized in that said motor core component comprises a core part made of a magnetic material and an insulator placed on the outer periphery of the core part and made of an insulating material, an that
the core part is formed by pressing and molding powder of magnetic material.

7. The motor core component as claimed in claim 1, characterized in that said tooth is shaped like a square pyramid frustum with the width narrowing from the outer peripheral piece side to the inner peripheral piece side in the transverse cross section.

8. The motor core component as claimed in claim 7, characterized in that the step is provided so as to rise from the outer peripheral piece side to the inner peripheral piece side in the transverse cross section of said tooth.

9. The motor core component as claimed in claim 7, characterized in that said tooth is provided with the width narrowing from the inner peripheral piece side to the outer peripheral piece side in the transverse cross section.

10. The motor core component as claimed in claim 1, characterized in that a joint face jointing the two step faces producing the step has an inclination of 60° or less relative to an extension face of the lower step face.

11. The motor core component as claimed in claim 1, characterized in that a corner produced by a joint face jointing the two step faces producing the step and the higher step face has roundness.

12. The motor core component as claimed in claim 1, characterized in that the outer peripheral surface of said tooth comprises a groove into which the conductor wire is fitted.

13. A motor component comprising a motor core component as claimed in claim 1 and a coil made of a wound conductor wire stored in a storage section of said core component, characterized in that the conductor wire forming the outer shape of said coil is placed on the same line.

14. A motor component forming method of:
providing a motor core component as claimed in claim 1;
normally winding a conductor wire along the outer periphery of a tooth between an outer peripheral piece and an inner peripheral piece starting at the outer peripheral piece end part or the inner peripheral piece end part of the tooth of the core component; and
terminating winding the conductor wire so that the conductor wire placed on the outermost side align on the same line.

15. The motor core component as claimed in claim 2, characterized in that n is an even number.

16. The motor core component as claimed in claim 2, characterized in that said motor core component comprises a core part made of a magnetic material and an insulator placed on the outer periphery of the core part and made of an insulating material.

17. The motor core component as claimed in claim 2, characterized in that the step is provided over all faces of the outer peripheral surface of said tooth, and that
further the step is provided so that when the cross section of said tooth is taken so as to be orthogonal to the center axis of a coil as the wound conductor wire on said tooth, the cross-sectional area becomes substantially equal.

18. The motor core component as claimed in claim 5, characterized in that said motor core component comprises a core part made of a magnetic material and an insulator placed on the outer periphery of the core part and made of an insulating material, an that
the core part is formed by pressing and molding powder of magnetic material.

19. The motor core component as claimed in claim 2, characterized in that said tooth is shaped like a square pyramid frustum with the width narrowing from the outer peripheral piece side to the inner peripheral piece side in the transverse cross section.

20. The motor core component as claimed in claim 7, characterized in that the step is provided so as to rise from the outer peripheral piece side to the inner peripheral piece side in the transverse cross section of said tooth.

21. The motor core component as claimed in claim 7, characterized in that said tooth is provided with the width narrowing from the inner peripheral piece side to the outer peripheral piece side in the transverse cross section.

22. The motor core component as claimed in claim 2, characterized in that the outer peripheral surface of said tooth comprises a groove into which the conductor wire is fitted.

23. A motor component comprising a motor core component as claimed in claim 2 and a coil made of a wound conductor wire stored in a storage section of said core component, characterized in that
the conductor wire forming the outer shape of said coil is placed on the same line.

24. A motor component forming method of:
providing a motor core component as claimed in claim 2;
normally winding a conductor wire along the outer periphery of a tooth between an outer peripheral piece and an inner peripheral piece starting at the outer peripheral piece end part or the inner peripheral piece end part of the tooth of the core component; and
terminating winding the conductor wire so that the conductor wire placed on the outermost side align on the same line.
